(19) United States
(12) Patent Application Publication
(10) Pub. No.: US 2009/0180024 A1
(43) Pub. Date: Jul. 16, 2009

(54) Image processing apparatus and image processing method

(75) Inventors: Siao-Huei Lai, Taipei County (TW); Chih-Hung Huang, Taipei County (TW)

Correspondence Address: BACON & THOMAS, PLLC, 625 SLATERS LANE, FOURTH FLOOR, ALEXANDRIA, VA, 22314-1176, US

(73) Assignee: Tenx Technology Inc., Taipei County (TW)

(21) Appl. No.: 12/213,634

(22) Filed: Jun. 23, 2008

(30) Foreign Application Priority Data
Jan. 15, 2008 (TW) 97101476

(51) Int. Cl. H04N 5/45

(52) U.S. Cl. 348/565; 348/E05.112

(57) ABSTRACT

The present invention discloses an image processing apparatus comprising a first input unit, a first scaler, a buffer unit, a first transparent unit, a second scaler and an image mixer. The invented image processing method comprises the steps of receiving first and second image data, scaling the size of image of the received image data, clearing the background of the first image data and superposing the first and second image data to form a synthetic image, with its sub-frame image having a user defined frame.

### FIELD OF THE INVENTION

The present invention relates to an image processing apparatus and an image processing method, especially to an apparatus and a method to generate images containing sub-frame images with user-defined frames.

### BACKGROUND OF THE INVENTION

Because of the newly developed technologies in the computer displaying devices, various new functions have been provided to the displaying device for the computer system. The digital displaying device that displays only one frame at one time can no longer satisfy the needs of the consumers. Therefore, the displaying device that provides the “picture in picture” (PIP) function has been introduced to the market and has become the main trend in the market.

Generally speaking, the PIP function is a screen edition function that displays simultaneously a main frame image and a plurality of sub-frame images. In the display of a PIP video equipment, the main frame image is generated by the computer system and the sub-frame images are input from various signal sources, such as a TV tuner, a VTR or a DVD player. However, there are some drawbacks in the conventional PIP technology.

FIG. 1 shows the main frame image and several sub-frame images displayed in a displaying device in the conventional PIP technology. In the figure, 100 is the main frame image and 101 and 102 are the sub-frame images. As shown in FIG. 1, in the conventional PIP technology the frames of the sub-frames are in the rectangular shape and the sub-frames are displayed by pasting them on top of the main frame image. In other words, in the conventional PIP technology although the sub-frame 101 is an astral shape and the sub-frame 102 is a portrait, they are displayed in the rectangular shape. The conventional PIP technology does not provide other shape for the sub-frame images. In addition, in the conventional art the sub-frames are not transparent; the important information in the main frame image would be blocked by the sub-frames. These technical limitations in the conventional PIP technology have also limited the scale of market for the PIP products.

It is thus necessary to provide a novel PIP technology that is able to generate the PIP image, wherein the frame of the sub-frame images is not limited to any particular geometric shape.

It is also necessary to provide a novel PIP technology that is able to generate sub-frame images with the user-define shapes.

It is also necessary to provide a new PIP technology so that in the PIP image, the important information in the main frame image is not blocked by the sub-frame images.

### OBJECTIVES OF THE INVENTION

The objective of the present invention is to provide a new image processing apparatus that is able to generate PIP images, with the frame of the sub-frame image not limited to any particular geometric shape.

Another objective of the invention is to provide an image processing apparatus that generates PIP images in which the sub-frame images have the user-defined shape.

Another objective of the invention is to provide an image processing apparatus that generates PIP images in which the sub-frame images may be penetrated by the main frame image.

Another objective of this invention is to provide an image processing method to generate PIP images with the frames of the sub-frame image not limited to any particular geometric shape.

Another objective of the invention is to provide an image processing method to generate PIP images in which the sub-frame images have the user-defined shape.

Another objective of the invention is to provide an image processing method to generate PIP images in which the sub-frame images may be penetrated by the main frame image.

### SUMMARY OF THE INVENTION

According to the present invention, an image processing apparatus and an image processing method are provided, to generate in a displaying device a main frame image and a plurality of sub-frame images with the user-defined frames. The image processing apparatus of the present invention comprises: A first input unit, a first scaler, a buffer unit, a first transparent unit, a second scaler and an image mixer. The input unit receives at least first image data and second image data. The first scaler is in connection with the input unit to scale the image of the first image data provide by the input unit. The buffer unit is in connection with the first scaler to temporarily store the first image data after they are processed by the first scaler. The first transparent unit is in connection with the first scaler to clear the background images or the background colors of the first image data in the buffer unit. On the other hand, the second scaler is in connection with the input unit to scale the size of image of the second image data from the input unit. The image mixer is in connection with the first transparent unit and the second scaler and superposes the first image data from the first transparent unit and the second image data from the second scaler, to form a synthetic image.

The image processing method of the present invention may be used in the above-mentioned image processing device and comprises the following steps: The input unit receives at least first image data and second image data. The first scaler processes the first image data of the input unit by scaling the size of image of the first image data. The buffer unit synchronizes the phases of the first image data and the second image data. The first transparent unit clears the background images or image colors of the first image data and provides the first image data to the image mixer. The second scaler processes the second image data from the input unit by scaling the size of image of the second image data and provides the processed second image data to the image mixer. The image mixer superposes the first image data, with the backgrounds having been cleared, and the scaled second image data to form a synthetic image, with its sub-frame images having a user-defined frame.

After the image data have been processed by the present invention, the image so generated preferably contains a main frame image and a sub-frame image and the sub-frame image has a user defined frame. The image data that are input to the input unit preferably include image data provided by two or more sources. Therefore, the synthetic image generated by the present invention would include one main frame image and one or more sub-frame images; each sub-frame image has a user-defined frame. The image so generated is a PIP image.

In one embodiment of the present invention, the first transparent unit clears the backgrounds of the image data by defining the color of the background image or the background colors as transparent.

The image processing device of the present invention may further comprise a second transparent unit, connected with the second scaler and the image mixer to clear the backgrounds of the scaled second data. Thereby, the roles of the first image data and the second image data, as they are the main frame image or the sub-frame image, are exchangeable

The buffer unit of the present invention may comprise a memory and a memory control unit. The memory control unit is in connection with the first scaler and the memory is in connection with the memory control unit. The memory is preferably an SDRAM, a DDR or a DDRII memory device.

In the image processing method of the present invention, the input unit may accept the input of two or more image data. By scaling, background clearing and superposing the input image data, a synthetic image is formed and the synthetic image so formed contains a main frame image and a plurality of sub-frame images that have a user-defined frame.

The phase synchronization of the first image data and the second image data may comprise the following steps: Store the scaled first image data in the buffer unit, read out the first image data from the buffer unit and transmit the first image data to the first transparent unit.

In the present invention the background clearing process of the image data may be realized by using the transparent unit to select a particular range of color gamut from the image data and to define the selected range of color gamut as transparent. It is also possible to select a plurality of ranges of color gamut and define the selected ranges as transparent. Here, the ranges of color gamut include the red color gamut, the green color gamut and the blue color gamut.

These and other objectives and advantages of the present invention may be clearly understood from the detailed description by referring to the following drawings.

### BRIEF DESCRIPTION OF THE DRAWINGS

FIG. 1 shows the main frame image and several sub-frame images displayed in a displaying device in the conventional PIP technology.

FIG. 2 shows the main frame image and several sub-frame images displayed in a displaying device in connection with the present invention.

FIG. 3 is the systematic diagram of the first embodiment of the image processing apparatus of the present invention.

FIG. 4 illustrates the flowchart for the image processing method used in the image processing apparatus of FIG. 3.

FIG. 5 is the systematic diagram of the second embodiment of the image processing apparatus of the present invention.

FIG. 6 illustrates the flowchart for the image processing method used in the image processing apparatus of FIG. 5.

FIG. 7 is the systematic diagram of the third embodiment of the image processing apparatus of the present invention.

FIG. 8 is the systematic diagram of the fourth embodiment of the image processing apparatus of the present invention.

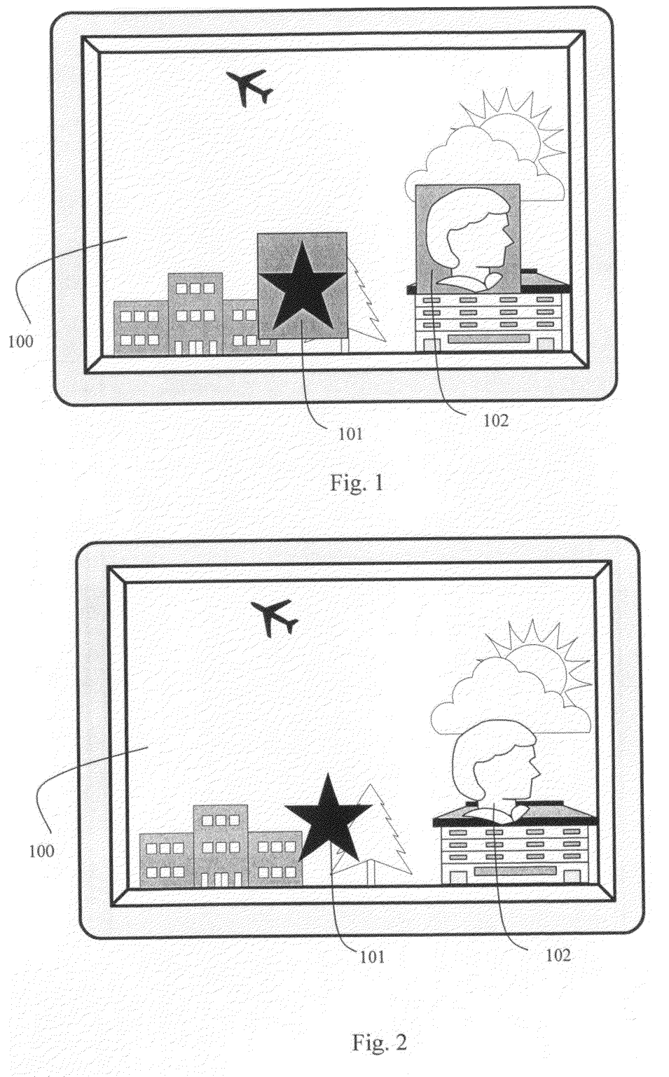

### DETAILED DESCRIPTION OF THE INVENTION

In order to overcome the technical limitations in the conventional PIP technology, the present invention provides an image processing apparatus and an image processing method, so to generate in a computer displaying device sub-frame images with the user-defined frames. FIG. 2 shows the main frame image and several sub-frame images displayed in a displaying device in connection with the present invention. In this figure, 100 represents the main frame image and 101 and 102 represent the sub-frame images. As shown in this figure, the sub-frame image 101 is an astral shape and the sub-frame image 102 is a portrait. Both sub-frame images 101, 102 use the edges of the images as their frame. The sub-frame images are displayed on the main frame image 100, with their frames not restricted to any particular geometric shape. In the displaying device the number of the sub-frame images is not limited. In addition, the image processing apparatus and method of the present invention are able to generate sub-frame images that may be penetrated by the main frame image, whereby the information of both the sub-frame image and the main frame image may be perceived by the user.

In the followings several embodiments of the present invention will be described for the purpose of illustrating the image processing apparatus and method of the present invention. It shall be noted that those skilled in the art may easily realize the advantages and functions of the present invention and derive different implementations based on the present invention. These variations, derivations and adaptations are within the scope of the present invention.

### EMBODIMENT I

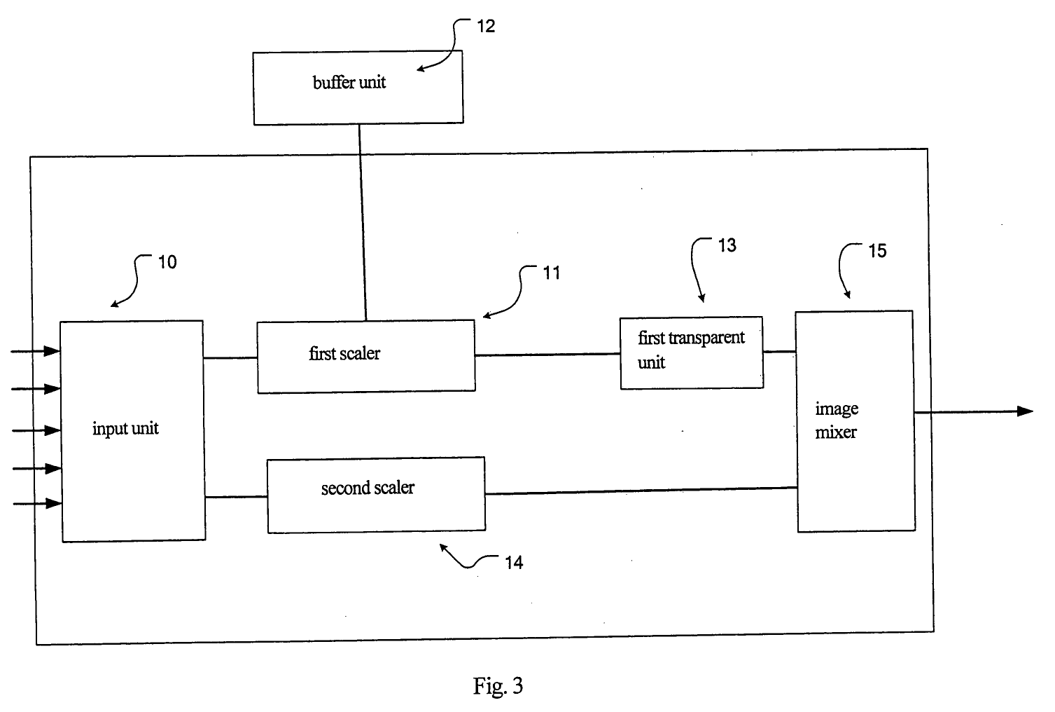

FIG. 3 is the systematic diagram of the first embodiment of the image processing apparatus of the present invention. As shown in this figure, the image processing device of this embodiment comprises an input unit 10, a first scaler 11, a buffer unit 12, a first transparent unit 13, a second scaler 14 and an image mixer 15.

In the image processing apparatus according to this embodiment I, the input unit 10 accepts at least first image data and second image data. The first scaler 11 is in connection with the input unit 10 to scale the size of image of the first image data from the input unit 10. The buffer unit 12 is in connection with the first scaler 11 and stores the scaled first image data. The first transparent unit 13 is in connection with the first scaler 11 and clears the background image or background colors of the first image data coming from the buffer unit 12. On the other hand, the second scaler 14 is in connection with the input unit 10 and scales the size of image of the second image data from the input unit 10. The image mixer 15 is in connection with the first transparent unit 13 and the second scaler 14 and superposes the first image data from the first transparent unit 13 and the second image data from the second scaler 14, to form a synthetic image. The synthetic image so generated includes a main frame image and a sub-frame image. The sub-frame image has a user-defined frame.

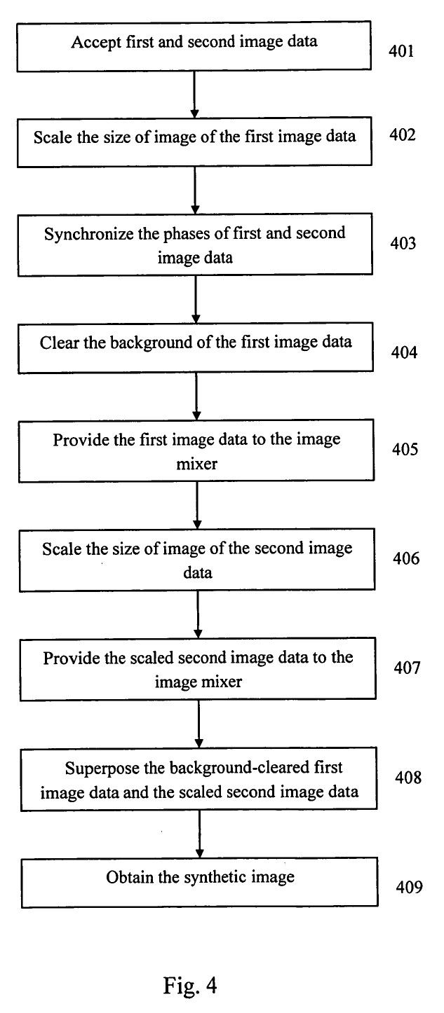

FIG. 4 illustrates the flowchart for the image processing method used in the image processing apparatus of FIG. 3. As shown in this figure, the image processing method in this embodiment uses the image processing apparatus of FIG. 3 to generate an image with its sub-frame image having a user-defined frame. The steps of the image processing method in this embodiment are: At 401 the input unit 10 accepts first image data and second image data. At 402 the first scaler 11 scales the size of image of the first image data supplied by the input unit 10. At 403 the buffer unit 12 synchronizes the phases of the first image data and the second image data. At 404 the first transparent unit 13 clears the background image or background colors of the first image data. At 405 the first image data are provided to the image mixer 15. At 406 the second scaler 14 scales the size of image of the second image data supplied by the input unit 10. At 407 the scaled second image data are provided to the image mixer 15. At 408 the image mixer 15 superposes the background-cleared first image data and the scaled second image data. At 409 a synthetic image with its sub-frame image having a user-defined frame is formed.

In this embodiment the input unit 10 may be designed to be able to accept image data supplied by more than two sources. In other words, the input unit 10 is able to accept the input of the first image data, the second image data and the image data provided by other sources. Therefore, the synthetic image so generated will contain a main frame image and a plurality of sub-frame images, with their frames not limited to any particular geometric shape.

In addition, because the first image data and the second image data are processed in separate channel and different processes, after they have been provided by the input unit 10, phase differences will be found when they are later provided to the image mixer 15. It is thus necessary to use the buffer unit 12 to synchronize the phases of the first and second image data, so to compensate the phase difference. Thereby the synthetic image produced by superposing the first image data and the second image data would be desirable. In the present embodiment, the phase synchronization of the first image data and the second image data may include the following steps: The scaled first image data are stored in the buffer unit 12, the first image data are read out from the buffer unit 12 and the first image data are provided to the first transparent unit 13.

The image generated by the image processing apparatus of the present invention includes a main frame image and a sub-frame image, with its frame not limited to any geometric shape. The frame of the sub-frame image is generated mainly by clearing the background information of the input image. In this embodiment, the step of clearing the background image or background colors of the image data may include the following steps: The first transparent unit 13 clears the backgrounds of the first image data by selecting a particular range of color gamut from the first image data and defining the selected range of color gamut as transparent. Thereby when the first image data are display, the background portions of the image are transparent. A sub-frame image with the desired frame is generated.

### EMBODIMENT II

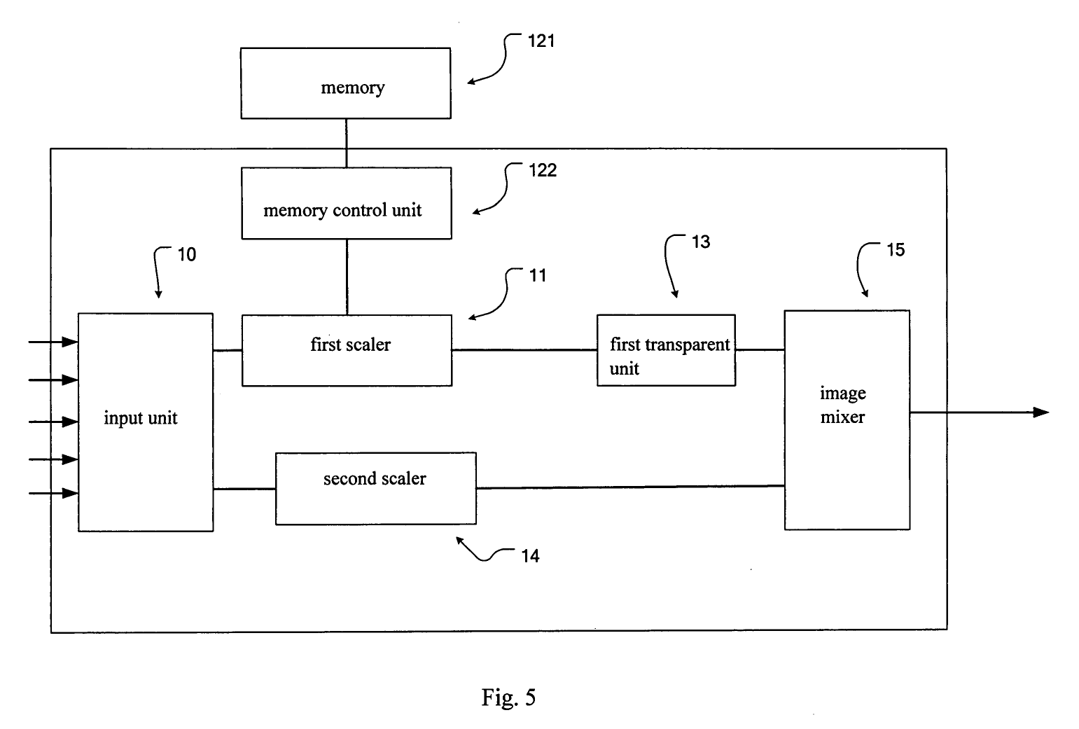

FIG. 5 is the systematic diagram of the second embodiment of the image processing apparatus of the present invention. In this figure, the elements that are the same as those in the FIG. 3 are labeled with the same reference numbers. As shown in FIG. 5, the image processing apparatus of this embodiment comprises: An input unit 10, a first scaler 11, a memory 121, a memory control unit 122, a first transparent unit 13 and a second scaler 14.

In the image processing apparatus according to this embodiment II, the input unit 10 accepts first image data and second image data. The first scaler 11 is in connection with the input unit 10 and scales the size of image of the first image data provided by the input unit 10. The memory control unit 122 is in connection with the first scaler 11 and the memory 121 is in connection with the memory control unit 122. Both in combination serve to synchronize the phases of the first and second image data. The first transparent unit 13 is in connection with the first scaler 11 and clears the background image or background colors of the first image data coming from the memory 121. On the other hand, the second scaler 14 is in connection with the input unit 10 and scales the size of image of the second image data provided by the input unit 10. The image mixer 15 is in connection with the first transparent unit 13 and the second scaler 14 and superposes the first image data from the first transparent unit 13 and the second image data from the second scaler 14, to form a synthetic image. The synthetic image so generated includes a main frame image and a sub-frame image. The sub-frame image has a user-defined frame.

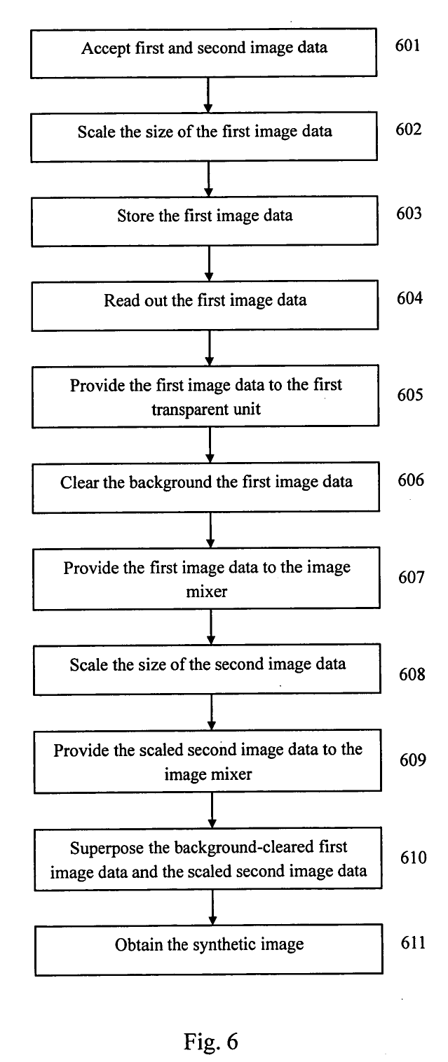

FIG. 6 illustrates the flowchart for the image processing method used in the image processing apparatus of FIG. 4. As shown in this figure, the image processing method in this embodiment uses the image processing apparatus of FIG. 4 to generate an image with its sub-frame image having a user-defined frame. The steps of the image processing method in this embodiment are: At 601 the input unit 10 accepts first image data and second image data. At 602 the first scaler 11 scales the size of the first image data supplied by the input unit 10. At 603 the memory control unit 122 stores the first image data in the memory 121. At 604 the memory control unit 122 reads out the first image data from the memory 121. At 605 the memory control unit 122 provides the first image data to the first transparent unit. At 606 the first transparent unit 13 clears the background image or background colors of the first image data. At 607 the first image data are provided to the image mixer 15. At 608 the second scaler 14 scales the size of the second image data supplied by the input unit 10. At 609 the scaled second image data are provided to the image mixer 15. At 610 the image mixer 15 superposes the background-cleared first image data and the scaled second image data. At 611 a synthetic image with its sub-frame image having a user-defined frame is formed.

In this embodiment, the input unit 10 is preferably designed to be able to accept image data supplied by more than two sources. In other words, the input unit 10 is able to accept the input of the first image data, the second image data and the image data provided by other sources. Therefore, the synthetic image so generated will contain a main frame image and a plurality of sub-frame images, with their frames not limited to any particular geometric shape.

### EMBODIMENT III

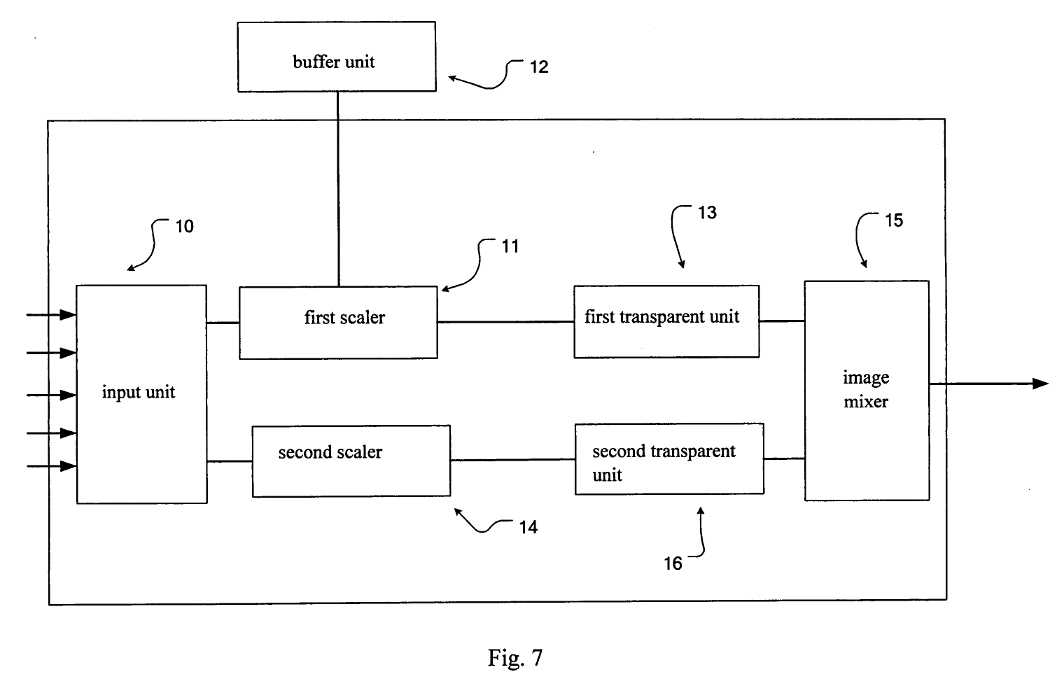

FIG. 7 is the systematic diagram of the third embodiment of the image processing apparatus of the present invention. In this figure, the elements that are the same as those in the FIG. 3 are labeled with the same reference numbers. As shown in FIG. 7, the image processing apparatus of this embodiment has generally the same structure of that of Embodiment I. The major difference is in that the image processing apparatus further comprises a second transparent unit 16. The second transparent unit 16 is connection with the second scaler 14 and the image mixer 15 and clears the backgrounds of the scaled second image data.

### EMBODIMENT IV

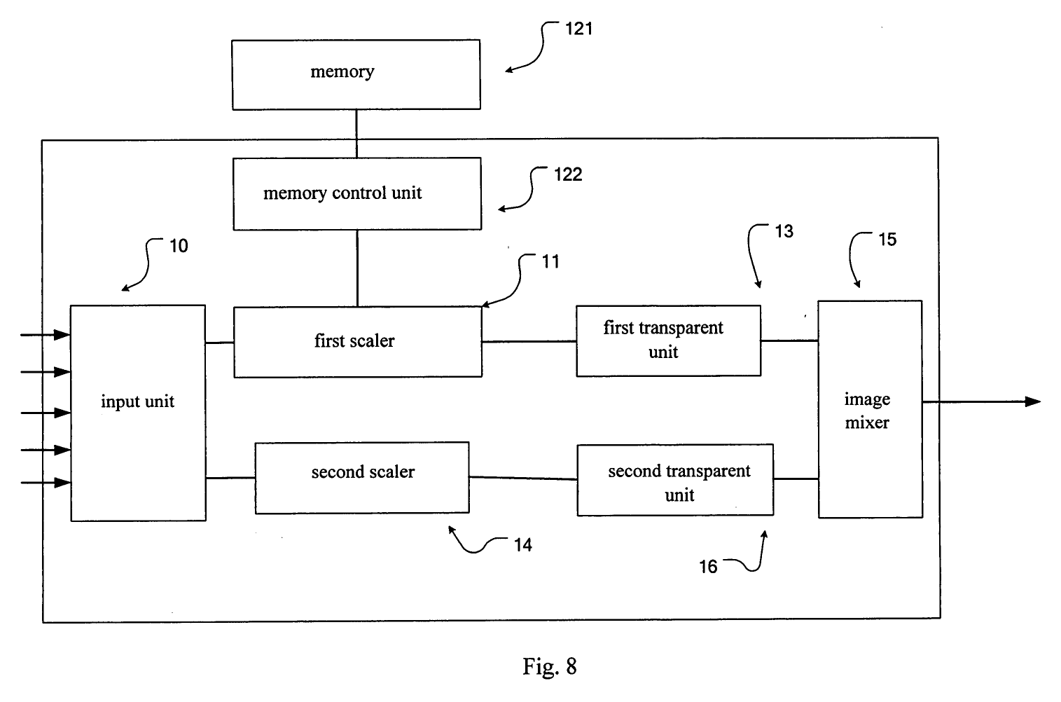

FIG. 8 is the systematic diagram of the fourth embodiment of the image processing apparatus of the present invention. In this figure, the elements that are the same as those in the FIG. 5 are labeled with the same reference numbers. As shown in FIG. 8, the image processing apparatus of this embodiment has generally the same structure of Embodiment II. The major difference is in that the image processing apparatus further comprises a second transparent unit 16. The second transparent unit 16 is connection with the second scaler 14 and the image mixer 15 and clears the backgrounds of the scaled second image data.

The image processing apparatus of the present invention may further comprise a multiplexer MUX. The multiplexer MUX is in connection with the second scaler 20 and the second transparent unit 16 and serves to switch the roles of the images, i.e., to select among the image data provided by different sources as the main frame image. It may further comprise a noise reduction unit, a time clock etc, to further enhance the quality of the image so generated.

The first transparent unit and the second transparent unit may each comprise a first brightness control circuit and a first contrast control circuit to modify the output images.

The image processing apparatus of this invention may further comprise a color temperature control unit (not shown), connected with the image mixer 15. It may further comprise an OSD mixer and an OSD display unit, to calibrate the output level of the three primary colors, so that the color temperature radiated by the displaying device would proximate the desired color temperature. In addition, a gamma calibration unit in connection with the OSD mixer and a dither unit in connection with the gamma calibration unit may also be provided in order to display the middle tones.

Nevertheless, the first and second scalers preferably comprise an X axis scaler, a Y axis scaler and a Z axis scaler (all not shown), wherein the X axis scaler is in connection with the input unit 10 and the memory control unit 122, the Y axis size control unit is in connection with the X axis scaler and the Z axis scaler is in connection with the first transparent unit 13.

The first and second image data respectively are preferably the 24-bit pixel data or the 30-bit pixel data. More preferably they are the 24-bit pixel data or the 30-bit pixel data defined by the RGB primary colors.

In the scaling steps of the image data, it is possible to use only one scaler to scale the size of image of the first and the second image data. The first and second image data may be overlaid by blending them in ratio, whereby the synthetic image so generated contains semitransparent or transparent sub-frame images.

As the present invention has been shown and described with reference to preferred embodiments thereof, those skilled in the art will recognize that the above and other changes may be made therein without departing form the spirit and scope of the invention.

What is claimed is:

1. An image processing apparatus, comprising:
an input unit to receive at least first image data and second image data;
a first scaler in connection with said input unit, to scale the size of image of said first image data;
a buffer unit in connection with said first scaler, to temporarily store aid scaled first image data;
a first transparent unit in connection with said first scaler, to clear the backgrounds of said first image data;
a second scaler in connection with said input unit, to scale the size of image of said second image data; and
an image mixer in connection with said first transparent unit and said second scaler, to superpose said first image data provided by said first transparent unit and said second image data provided by said second scaler to form a synthetic image.

2. The image processing apparatus according to claim 1, wherein said first transparent unit clears said background of said first image data by defining the color of said background as transparent.

3. The image processing apparatus according to claim 1, further comprising a second transparent unit in connection with said second scaler and said image mixer, to clear the background of said scaled second image data.

4. The image processing apparatus according to claim 1, wherein said buffer unit comprises a memory and a memory control unit; wherein said memory control unit is in connection with said first scaler and said memory is in connection with said memory control unit.

5. The image processing apparatus according to claim 3, wherein said buffer unit comprises a memory and a memory control unit; wherein said memory control unit is in connection with said first scaler and said memory is in connection with said memory control unit.

6. The image processing apparatus according to claim 1, wherein said first scaler comprises an X axis scaler, a Y axis scaler and a Z axis scaler.

7. The image processing apparatus according to claim 3, wherein said first scaler comprises an X axis scaler, a Y axis scaler and a Z axis scaler.

8. The image processing apparatus according to claim 4, wherein said first scaler comprises an X axis scaler, a Y axis scaler and a Z axis scaler.

9. The image processing apparatus according to claim 5, wherein said first scaler comprises an X axis scaler, a Y axis scaler and a Z axis scaler.

10. The image processing apparatus according to claim 1, further comprising a multiplexer in connection with said second scaler.

11. The image processing apparatus according to claim 3, further comprising a multiplexer in connection with said second scaler.

12. An image processing method, comprising the following steps:
receiving at least first image data and second image data;
scaling the size of image of said first image data;
synchronizing the phases of said first and second image data;
clearing the background of said first image data;
scaling the size of image of said second image data; and
superposing said background-cleared first image data and said scaled second image data to form a synthetic image.

13. The image processing method according to claim 12, wherein said superposing step comprises the step of blending said first image data and said second image data in a ratio.

14. The image processing method according to claim 12, wherein said superposing step comprises the step of defining said image of said first image data as semitransparent.

15. The image processing method according to claim 12, wherein said synchronization step comprises the steps of:
storing said scaled first image data in a buffer unit; and
reading out said first image data from said buffer unit.

16. The image processing method according to claim 12, wherein said background clearing step comprises the steps of selecting a particular range of color gamut from said first image data and defining said selected range of color gamut as transparent.

17. The image processing method according to claim 12, wherein said background clearing step comprises the steps of selecting a particular range of color gamut from said first image data wherein said particular range is a range selected from the group consisted of the red color gamut, the green color gamut and the blue color gamut.

18. The image processing method according to claim 12, wherein said background clearing step comprises the steps of selecting a plurality of ranges of color gamut from said first image data and defining said selected ranges of color gamut as transparent.

19. An image processing method to process at least first image data and second image data in an image processing device, comprising:
an input unit to receive at least first image data and second image data;
a first scaler in connection with said input unit to scale the size of image of said first image data;
a buffer unit in connection with said first scaler to temporarily store aid scaled first image data;
a first transparent unit in connection with said first scaler to clear the backgrounds of said first image data;
a second scaler in connection with said input unit to scale the size of image of said second image data;
an image mixer in connection with said first transparent unit and said second scaler, to superpose said first image data provided by said first transparent unit and said second image data provided by said second scaler to form a synthetic image; said method comprising the steps of:
said input unit receives at least first image data and second image data;
said first scaler scales the size of image of said first image data;
said buffer unit synchronizes the phases of said first and second image data;
said transparent unit clears the background of said first image data;
said second scaler scales the size of image of said second image data; and
said image mixer superposes said background-cleared first image data and said scaled second image data to form a synthetic image.

20. The image processing method according to claim 19, wherein said superposing step comprises the step of blending said first image data and said second image data in a ratio.

21. The image processing method according to claim 19, wherein said superposing step comprises the step of defining said image of said first image data as semitransparent.

22. The image processing method according to claim 19, wherein said synchronization step comprises the steps of:
storing said scaled first image data in a buffer unit; and
reading out said first image data from said buffer unit.

23. The image processing method according to claim 19, wherein said background clearing step comprises the steps of selecting a particular range of color gamut from said first image data and defining said selected range of color gamut as transparent.

24. The image processing method according to claim 19, wherein said background clearing step comprises the steps of selecting a particular range of color gamut from said first image data wherein said particular range is a range selected from the group consisted of the red color gamut, the green color gamut and the blue color gamut.

25. The image processing method according to claim 19, wherein said background clearing step comprises the steps of selecting a plurality of ranges of color gamut from said first image data and defining said selected ranges of color gamut as transparent.
